(19) United States
(12) Patent Application Publication
(10) Pub. No.: US 2011/0306322 A1
(43) Pub. Date: Dec. 15, 2011

(54) Methods and apparatus for providing information services during the normal alert of an outbound communication session

(76) Inventor: Peter O. Roach, JR., Jacksonville, FL (US)

(21) Appl. No.: 11/495,051

(22) Filed: Jul. 28, 2006

Related U.S. Application Data
(60) Provisional application No. 60/709,203, filed on Aug. 18, 2005.

(51) Int. Cl. H04W 4/12

(52) U.S. Cl. 455/412.1

(57) ABSTRACT

Methods and apparatus are provided for provisioning a user controlled alerting message to the calling party on a telecommunications session. The alerting message is designed to be able to replace or augment the normal alert message and to provide an information service to the calling party during a period that is typically non-productive.

### RELATED APPLICATIONS

The present application is related to the subject matter disclosed by and claims priority under 35 U.S.C. 119 to U.S. Provisional Patent Application Ser. No. 60/709,203, filed Aug. 18, 2005, entitled “Methods and Apparatus for providing information services during the normal alert interval of an outbound communication Session” Applicant hereby incorporates by reference the complete disclosure of said referenced provisional patent application.

### TECHNICAL FIELD

The present invention relates generally to a wired or wireless communications network and more particularly to the use and provisioning of information services during the non-productive time normally associated with the origination of a communications session; e.g., the alerting cycle.

### BACKGROUND OF THE INVENTION

As our daily lives become more and more hectic we begin to look for ways to better utilize any downtime available. This trend is most evidenced by the strong growth and subscriber acceptance of mobile phones as a daily necessity. Subscribers now are able to take advantage of the time in the car, commuting, waiting for appointments, etc to increase their productivity and efficiency while performing everyday activities.

This trend toward better utilizing our time has been combined with a trend toward more and timely information sources to keep us current on our work environment, family life, hobbies, personal interest, markets, sports, and other similar areas of interest. This trend can be seen through the advancement of the internet, instant messaging, information services delivered to our cell phone, wireless e-mail, the wide spread acceptance of wirelessly connected personal digital assistants and other means of delivering timely and relevant information to the subscriber.

These current trends lead one to believe that the value of effectively filling ones dead time has become a strong driving factor in current behavior. Many in our society desire to have the relevant information presented to them in an easy to understand manner when and where they have slack time or free time in their schedules to process and handle the information.

Accordingly, there is currently a small amount of slack time in most people's normal everyday lives while they are listening to the normal alerting tone initiating an outbound electronic communications; e.g., the ringing associated with placing an outbound telephone call.

An alerting tone is typically played to the person initiating the communications session or calling party (CP) while the person receiving the communications session or called party (CdP) is being alerted to the existence of an inbound communications request by their communications device. In the case of a mobile phone, the CdP must find, retrieve, screen the calling party name/number, and answer the incoming communications before a communications session can begin. This provides a short period of time when the CP is typical listening to an alerting tone.

The period of time it typically takes to alert the CdP and have them acknowledge the communication request from the CP is in the range of 15-30 seconds; however, the interval can be almost instantaneous to very long depending on many factors influencing the routing and answering of the call.

In essence the current alerting tones and called party messages, while entertaining, typically lack the ability to provide the CP a relevant and customizable information source. Accordingly, there is a need to overcome the limitations of the prior art by adapting an outbound communications path to enable the provision of a unique information source delivered to the party establishing the communications path during the alerting and initial phase of a communications session.

### BRIEF DESCRIPTION OF THE DRAWINGS

FIG. 1—Outbound alert substitution using CAMEL in a cellular network

FIG. 2—Outbound alert substitution using a Services Node in a cellular network

FIG. 3—Flow chart for outbound alert substitution call logic 1 of 3

FIG. 4—Flow chart for outbound alert substitution call logic 2 of 3

FIG. 5—Flow chart for outbound alert substitution call logic 3 of 3

FIG. 6—Outbound alert substitution using a services node in the cellular network with visual alert

FIG. 7—Outbound alert substitution using a CAMEL trigger in a mobile network with a profile database

### DETAILED DESCRIPTION OF EXEMPLARY EMBODIMENTS

The present invention solves the problems of the prior art by providing an apparatus and method for allowing the CP to provision their outbound communications path to provide a unique information service in place of the normal alerting tone or the alerting signal (outbound alert replacement service or OARS). OARS would allow the CP to provision information services specifically tailored to their needs and thus allow the CP to become more efficient or effective in their lives

The first method and apparatus disclosed to solve the problem is to allow the CP to substitute the normal alerting signal provided by the network or the alerting signal provided by the CdP with their own alerting signal or information service (IS).

Examples of ISs are:
Music
Traffic alerts
   Alerts covering the subscriber's homeward route—played after X hour in the afternoon on weekdays
   Alerts covering the subscriber's normal route to work—played before Y hour in the morning on weekdays
Weather reports
Number of voice mails/emails or other similar communications waiting
Calling name of new voice mails waiting
Name/header information of new e-mails waiting
Sports scores
Information on how to navigate a voice response unit associated with the dialed number
Messages
   Family
   Work colleagues; e.g., secretary
   Information pertaining to the CdP taken from the CP personal contact manager software; e.g., remember to talk about x or the report is due tomorrow
Updates to the CP electronic calendar
Meeting requests
Reminders
   Meetings in the near future
   Birthdays
   Upcoming deadlines
Alerts
   Stock prices
   Market trends
   Sports scores
   Gossip
   Breaking news
Motivational sayings
Personal mantras
News Headlines
Location based information (much of this information could be screened based on the CP profile stored in a central server)
   Lunch specials in the immediate location when calling just prior to lunch hour
   Sale information for stores in the local area
   Inclement weather alerts
   Weather in the immediate location
   Current location of loved ones, elderly parents, friends
   Emergency messages or situational awareness based on events or emergency responders in proximity to the calling party.
Visual information
   Picture of CdP
   Recent contact information regarding the CdP; e.g., subject of last call taken from CP's personal contact manager software presented via text
   Maps to CdP location
   Maps of location surrounding CP
   Traffic alerts
   Scheduling information taken from CP's calendar manager software
   Video feed
   News stories
   Camera feed
      i. Home surveillance
      ii. Elderly parent
   Any of the audio ISs displayed in a visual manner
   Advertising
   Generic advertising
   Advertising tailored to the CP based on the profile stored
   Advertising/information based on the CdP information
      i. Advertising/information for the CdP
      ii. Advertising/information for competitors of the CdP
      iii. Advertising/information for ancillary offerings based on the CdP identity; e.g., if the CP is calling the Mercedes dealer the service may offer him Mercedes mechanics in the area.

The number and extent of ISs that can be offered is practically unlimited. The IS descriptions provided in this disclosure are for illustration purposes only and are not intended to limit the scope of the invention. It is the inventor's intention the disclosed invention can be utilized with virtually any IS that can be presented in a short amount of time. Also, several ISs may be presented simultaneously. For example, the user may hear an audio IS and, at approximately the same time, view a video IS. These ISs can be linked and deal with the same issue; however, they can deal with separate issues. For example, the user upon dialing the number of a local restaurant could hear an IS of the specials of the day at the restaurant while having an IS of a map with directions to the restaurant displayed on their handset. Alternatively, the user may hear an IS through the audio path indicating they may ‘pre order’ their meal while being presented a menu on the video path. In this example the information presented on the video path would likely be persisted after the communications session with the CdP was connected; however, the audio information would be terminated when the communications path was connected. It is possible to allow the audio IS to be terminated when or shortly after, the call was connected, and to continue the video or visual IS to allow the user to deal with them while the communications session was active.

OARS functionality can be provisioned in a number of different manners. For example OARS can be enabled by allowing the CP's communications device to substitute the normal alert signal for a CP defined alert message within the communications device itself. OARS can also be enabled by allowing the communication system serving the CP's communications device to offer OARS service. Alternatively, OARS can be provisioned by a third party platform with a connection to the communications system serving the communications device.

The advantage of provisioning the CP communications device to perform OARS is the functionality can easily roam with the user when the CP communications device is a mobile phone. This would mean the roamed to network would not be required to have the functionality needed to offer OARS as the functionality would be imbedded within the CP's communications device; however, technologies such as IP Multimedia Subsystem (As defined by 3GPP, the standard herein incorporated by reference, or Internet Engineering Task Force the standard herein incorporated by reference, hereafter referred to as IMS) can be used to allow services to seamlessly be provided across multiple networks and may be utilized to provision OARS. To enable this functionality in the communications device, the communications device would be programmed to provide the information during the time interval the communications device is receiving a signal indicating the network is alerting the CdP. The functionality to perform OARS on the voice path of the communications device could be implemented by substituting the tone received by the communications device with a CP generated information message in the form of a sound generated on the voice path to the CP. This would allow the CP to hear specified information during the alert cycle of an originated communications. The information needed to construct the sound generated on the voice path to the CP could be stored locally in the CP's communications device, retrieved in real time from the network using a second communications path, or retrieved in advance of the communications session and stored in the communications device for play back during the alerting phase of the communications session.

The advantage of provisioning the network serving the CP communications device to provide OARS is the equipment used to provide the service can be shared among multiple different users and can be easily upgraded and enhanced by the network operator. One skilled in the art, utilizing this disclosure, can determine other locations in the network that can be provisioned to provide OARS. It is the intention of the remainder of this disclosure to teach the preferred method of placing OARS functionality at a point in the network; however, it should be understood the preferred method disclosed is intended as an exemplary method only and in no way should be viewed as limiting the disclosure to only the described preferred method. Utilizing this disclosure one skilled in the art can see how the disclosed invention can be placed in the CP's communications device or at another place further into the network; e.g., associated with the gateway MSC (GMSC), tandem office, or other similar location.

When the functionality to offer OARS is provisioned in the network, the preferred method would be to provision the information service in the home serving communications network of the communications device such as, a mobile network, landline network, server connected to the internet, Wireless Local Network (WLAN) Switch, Private Branch Exchange (PBX), or other similar network interface point. The OARS can be provisioned in the network using a Service Node (SN), IP Multimedia Subsystem (IMS) applications processor, landline switching system, IP connected server, WLAN Switch, PBX or other similar platform. Alternatively, the provision of OARS can be performed by utilizing Customized Applications for Mobile network Enhanced Logic (CAMEL), IMS, Advanced Intelligent Network (AIN), Wireless Intelligent Network (WIN) as defined by the Telecommunications Industry Association (TIA) or other similar architecture. The equipment and/or network functions needed to provide OARS will hereafter be generically be referred to as “OARS Server” even though this functionality may be distributed over numerous platforms in the network.

The preferred method to provide the needed functionality entails provisioning the home network with the capability of recognizing the alerting phase of an outbound call. This functionality can be provided by an out of band signaling method such as Signaling System number 7 (SS7), Session Initiation Protocol (SIP), in band signaling protocol, monitoring the incoming voice path for progress tones, utilizing speech recognition technology, or some combination of these or similar methods. When the OARS Server recognized a CP communications path is in the alert phase of communications, it would then mute or discontinue the forward voice path from the network and inserts the CP desired IS. The voice path from the OARS Server to the CdP may optionally also be muted during the provision of the information service in order to ensure the CdP does not hear the information service provided to the CP.

There are multiple enhancement to the basic invention. These enhancements can be offered individually or can be offered in combination. These enhancements are:
a. After the OARS Server detects the alerting phase of the communications session is complete, the OARS Server can choose to either truncate the CP IS at the current point or, in the preferred implementation, the OARS Server could determine how much longer the IS has remaining. If the remaining duration of the IS is under a predetermined threshold, the OARS Server can alternatively allow the message to continue until completion. This feature along with the lower audio path from the CdP feature (explained later in this document) could allow the CP to hear the remainder of the message at the same time the CdP is providing the greeting associated with a normal voice communications.
b. While the IS is being played to the CP the voice path from the CdP to the CP can remain unmuted; however, the audio level could be lowered by a certain degree. This Lower Audio Path (LAP) feature allows the CP to be aware of the communications from the CdP while listening to the end of the IS or possibly responding to the query offered by the OARS Server. In this manner the OARS Server can finish providing the information service while the CP is providing the typical greeting. Optionally it may be desirable to gradually bring the audio level from the CdP up slowly once the call has been connected. This would allow the CP to begin to hear a greeting or other preliminary communications from the CdP.
c. When a call attempt is made by the CP the OARS Server can delay the establishment of the communications path between the CP and the CdP for a period of time while an information service is being provided to the CP. This functionality can be optional according to the priority of the particular information service. For example, if the CP had an information service consisting of a voice message from his secretary canceling an imminent meeting, the OARS Server could delay the call set up until after the message was presented to the CP.
d. After the IS is provided to CP, the CP can be prompted to provide an answer to a question posed by an IS. An example of this type of question could be from a secretary wishing to place a meeting on the CP's schedule. The secretary could ask “Can you meet with Bob Smith Tuesday at 2:00 to discuss budgets?”. The CP input could be given by depressing a predetermined key associated with the communications device or through the use of voice detection and/or recording to capture the response. The response could then be sent by an electronic message to the party leaving the message; e.g., e-mail containing a voice file, Multimedia Messaging Service (MMS) using a cell phone, or other similar method.
e. During the time a CP is listening to an IS or for a short time thereafter the CP could prompt the OARS Server to save or replay the information service currently being presented by depressing a predetermined key associated with the communications device or through the use of voice detection. It is also possible to allow the CP to press a predetermined key to have the IS presented at a later time; e.g., at the end of the call session or on a subsequent communications session after the completion of the call session.
f. The IS provided could be triggered by the destination address of the outbound communications path. For example, if the CP is establishing a communications path to a movie theater the IS could read or display the movie schedule for the next several hours or alternatively allow the user to book and purchase tickets to the movie.
g. The OARS Server can be programmed to play a tone, an audible click, or other indication to the CP when the connection to the CdP is established. This allows the CP to know approximately when the information service has finished and communications can begin with the CdP. Other methods to provide the same functionality are:
   Placing an unobtrusive tone on the line while an IS is being provided or after the IS is completed
   Placing a small amount of noise on the line while the IS is being provided
   Changing the line level while the information service is being provided
   Other similar method to make the presence or absence of the information service obvious to the CP.
h. The OARS service can be provided for communications attempts from the mobile network, landline network, voice over IP network, or other public or private means of conveying voice or video information between two or more parties.
i. The IS can be visually displayed in conjunction with or as an alternative to being presented via the audio channel. Examples might be textual information, information taken from a personal information manager relating to the CdP, video, or personalized web page presented on the screen of the CP's communications device, or other similar information. The visual information service would be programmed to automatically display on a screen or other device associated with the CP's communication device when the CdP was being alerted. As an option, the visual information can be persisted after the communications path with the CdP was established. This would allow the CP to continue to view and gain use from the visual information even after the communications session was established.
   i. The OARS Server could be programmed to provide an audio alert to the CP to indicate the presence of a visual message on the communications device; e.g., when dialing a restaurant an audio message could indicate “You can view our daily specials on your mobile phone now”.
j. When establishing multiple different communications sessions different IS messages can be rotated to the CP. For example the CP may want to hear the weather when establishing the first communications session, selected stock prices when establishing the second communications session, current traffic conditions when establishing the third communications session, etc.
k. When the CP establishes a communications session different IS messages can be prioritized for presentation according to a ranking system. For example a spouse, upon recording a reminder to ‘pick up the boys at school’ could designate the message as urgent. This would place the message at or near the top of the queue for messages to be displayed to the CP. Another option would be to allow all urgent messages to be played and handled before the call set up is established.
l. While a IS is being played the CP can use the keypad of the communications device to alter the behavior of the system. For example dialing pad keys (or soft keys on the display) on the communications device could be designated for functions such as skip this message, delete this message, respond yes, respond no, escape key to automatically terminate the IS and route the call, or other similar functionality. This functionality could be offered via voice recognition in addition to, or in substitution, of the key input.
m. The communication subscriber or another party representing the CP can access a website or similar means to alter the IS delivered. Examples are allowing desired ISs to be selected from a list of available ISs, automatically providing routing information for the CP's daily commute, and allowing the system to determine traffic conditions on this route to be presented within a certain time of the CP's scheduled commute. These examples are not intended to define the scope of alterations possible by the communications subscriber and one skilled in the art, utilizing this disclosure, can determine how other ISs may be altered or prioritized to enhance the CP experience when utilizing OARS.
   i. The location of the CP, if known, can be used to determine if the traffic conditions on the route input should be presented or altered. For example, if a mobile subscriber was roaming outside of their home network, the IS containing the traffic information could be substituted or suppressed.
n. The IS provided can be triggered or determined by a demographic or other profile stored for the CP. By utilizing a profile the IS can be adapted to the CP and presented in a manner that would fit the best with the CP's demographic information accessible by the IS provider.
o. It is desirable to allow the system to detect if an emergency or other specified type of call is being originated subsequently bypass any IS and route the call directly. This allows these call types to be routed as rapidly as possible without distracting the CP with an IS.

While the preferred method of the current invention disclosed may tend to favor a type of network or describe particular network architecture, it is the intention of the disclosure to teach how to utilize the current invention on various types of communications networks; e.g., fixed, mobile, WLAN, GSM networks, CDMA networks, W-CDMA networks, WiMax networks, WiBro networks, intelligent network architecture, circuit switched, IP, or hybrid network architectures. One skilled in the art, utilizing the information in this disclosure, can determine other methods and apparatus of providing a user defined information source in place of the alert signal on an outbound communications path. It is the intention of this disclosure not to limit the use of these techniques merely to the stated disclosures but to also include features normally found in voice response units, services nodes, intelligent network platforms, IMS architecture as defined by the 3GPP, or other similar methods into the disclosed invention.

Based on the foregoing, it can be seen that the present invention provides methods and apparatuses for providing a user defined information source in place of the alert signal on an outbound communications path. Many other modifications, features, and embodiments of the present invention will become evident to those of skill in the art. It should be appreciated, therefore, that many aspects of the present invention were described above by way of example only and are not intended as required or essential elements of the invention unless explicitly stated otherwise. Accordingly, it should be understood that the foregoing relates only to certain embodiments of the invention and that numerous changes may be made therein without departing from the spirit and scope of the invention as defined by the following claims.

### DETAILED DESCRIPTION OF THE DRAWINGS

The numbering convention used in this document to describe the figures includes the figure number as well as the number of the individual component within the numbers separated by a dash. For example 1-4 would refer to the component labeled with a ‘4’ in figure number 1.

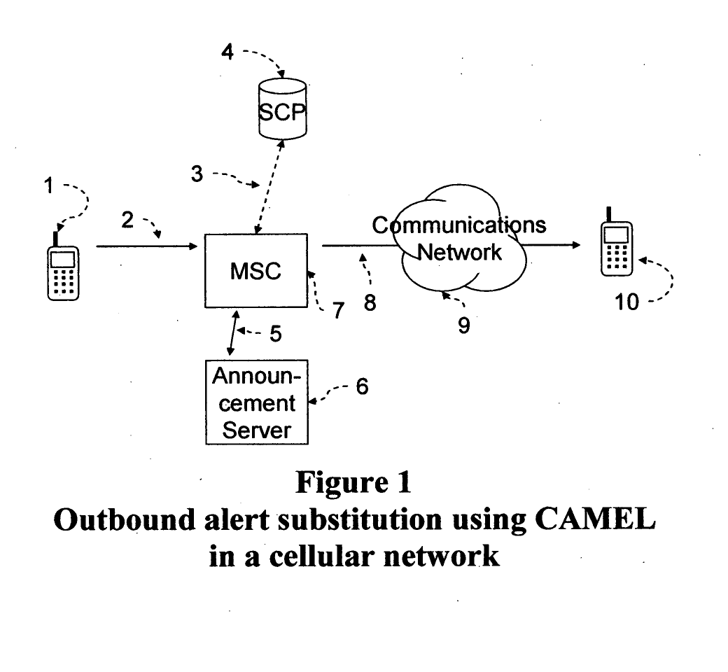

Referring now to FIG. 1. This illustrates a wireless network supporting outbound alert substitution using CAMEL intelligent network architecture. 1-1 represents a user of a mobile phone placing an outbound call from their mobile phone to the network. The communications path 1-2 can consist of radio waves, radio base stations, transport network, base station controller and other apparatus necessary for normal operation of the cellular radio and backhaul network. After transversing the communications path, the call origination request then arrives at the mobile switching center (MSC) 1-7. Upon receiving the call origination request MSC 1-7 would recognize the calling communications device 1-1 had a CAMEL call origination trigger associated with their service. The MSC 1-7 would then query a SCP 1-4 via a communications link 1-3 to determine how to appropriately handle the call. SCP 1-4 would instruct the MSC 1-7 to route the call to an announcement server 1-6 via a communications path 1-5. The announcement server 1-6 can alternatively be connected to the MSC 1-5 via dedicated trunks or release link trunks. In the CAMEL implementation the CAMEL SCP 1-4 could instruct the MSC 1-7 to connect to the announcement server 1-6 only to play the information service and retrieve any input.

The logic in the SCP 1-4 would determine if the call should be routed while the announcement is being played or alternatively if the call set up should be delayed in order to play a message that was indicated for urgent delivery or other similarly designated messages. However, if the outbound communications request 1-2 was being routed while the message from the announcement server 1-6 was being played to the user of the communications device 1-1; the announcement server 1-6 would monitor the communications link 1-5 for the alerting messages coming from the communications network 1-9 via the communications link 1-8. The announcement server 1-6 can monitor the communications link 1-5 by detecting in-band tones and messages, out-of-band signaling or some combination of the two. The announcement server 1-6 can also utilize voice detection and analysis in conjunction with the aforementioned monitoring techniques to determine the status of the communications link 1-5.

The announcement server 1-6 plays the announcements for the communications device 1-1 during the alerting phase of the communications request. Also, depending on the configuration and the designation of the message being played to the communications device 1-1, the announcement server 1-6 could alternatively select to play the message for a short duration before the alerting phase or to continue playing the message after the alerting phase of the communications.

The announcement server 1-6 could also be equipped with a method of reducing the level of an audible alert signal arriving from the communications path 1-8 to a point where the message being provided from the announcement server 1-6 to the user of communications device 1-1 would be clearly audible over the normal alerting announcement coming from the communications network 1-9. Alternatively the message server 1-6 could choose to mute audible signals received on the communications path 1-5 that indicated the communications network 1-9 was attempting to alert the communications device 1-10.

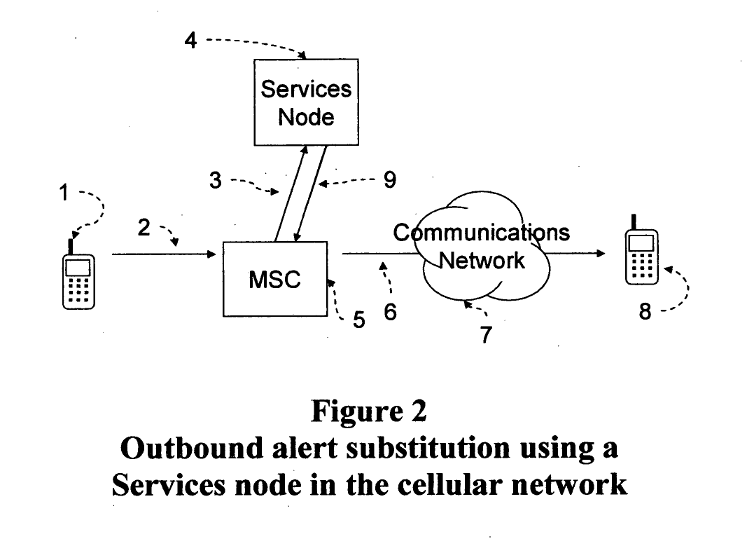

Referring to FIG. 2, the outbound alerting substitution service can be provided by a services node 2-4 architecture. In this case the MSC 2-5 would first determine if the call was destine for an emergency call center or another similar address. If the call was so destined the services node 2-4 would not be involved in the call routing.

In the services node 2-4 architecture the incoming communications request 2-2 from the communications device 2-1 would arrive at the MSC 2-5 and be routed to the services node 2-4. The services node 2-4 would then apply the logic to determine if the call setup should be delayed, an urgent or other similarly marked message should be played, and input collected before call setup progressed.

If the call was destined to be routed while the message was being played to the user of communications device 2-1, the services node 2-4 would route the communications request over the communications path 2-9 to the MSC 2-5 using the identity of the communications device 2-1 and normal call setup would proceed. The call routed over the communications path 2-9 would be marked to indicate that the services node 2-4 had already processed the call, thus eliminating the potential for the MSC 2-5 to attempt to reroute the call back to the services node 2-4.

The services node 2-4 would then connect the call and it would begin playing the messages it had stored for the user of communications device 2-1. However, if the services node received a busy condition, incorrect number, network busy, or other such condition when it attempted to set up the call, the services node 2-4 would then connect the message received from communications network 2-7 to the communications device 2-1. This would allow the user of communications device 2-1 to process the information provided by the communications network 2-7.

Once the communications was established through the services node 2-4, the services node 2-4 would continue to monitor the communications path 2-9 to determine when the alerting of communications device 2-8 was complete. Also, depending on the configuration and the designation of the message being played to the communications device 2-1, the services node 2-4 could alternatively select to play the message for a short duration before the alerting phase or to continue playing the message for a short duration after the alerting phase of the communications. Thus maximizing the time allowed to play the message or to compete a partially played message.

The services node 2-4 could also be equipped with a method of reducing the level of an audible alert signal arriving from the communications path 2-6 to a point where the message being provided from the announcement server 2-4 to the user of communications device 2-1 would be clearly audible over the normal alerting announcement coming from the communications network 2-7. Alternatively the services node 2-4 could choose to mute any audible signals received on the communications path 2-6 that indicated the communications network 2-7 was attempting to alert the communications device 2-8.

It should be understood that the separate communications networks 2-7 or 1-9 as well as the communications link 2-6 or 1-8 can be internal to MSC 2-5 or 1-7 respectively. It should also be understood services node 2-4 or announcement server 1-6 can be internal to MSC 2-5 or 1-7 respectively. It should also be understood that the services node 2-4 or the announcement server 1-6 can be alternatively configured to connect the call back through a second network (not shown) or may be directly connected to the communications network 2-7 or 1-9 to complete the call to the communications device 2-8 or 1-10 respectively.

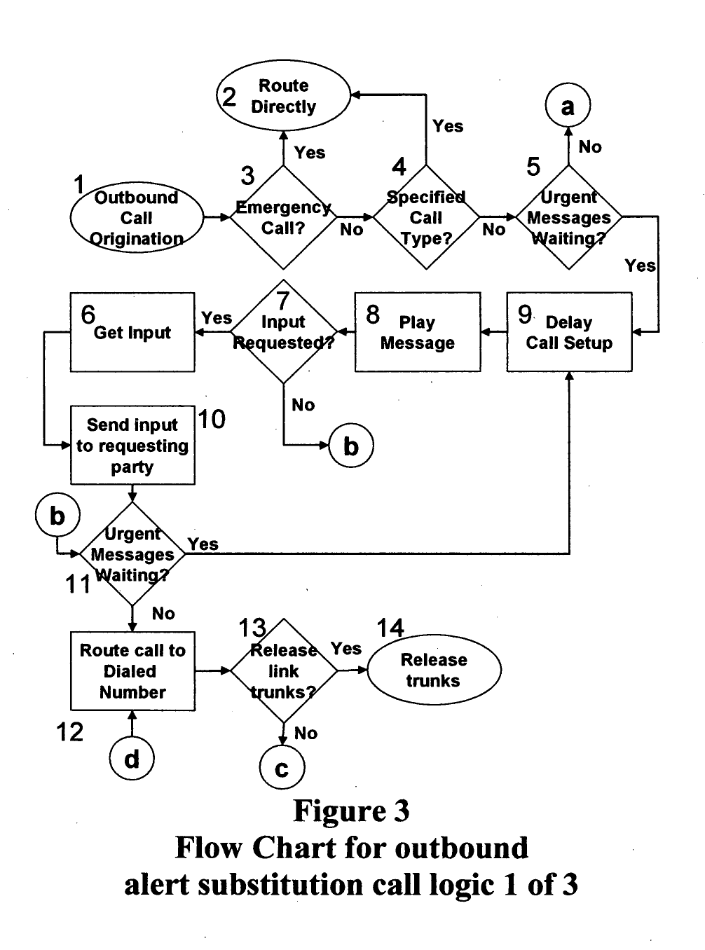

Referring now to FIG. 3, this is a flow chart of one set of logic that can be used in providing an alert substitution service. An outbound call origination 3-1 is detected, the logic determines if it is an emergency call 3-3 then the call is routed using normal call set up logic 3-2 and the alert substitution service can be avoided. Alternatively, if a specified call type 3-4 is dialed then the call is routed using normal call set up logic 3-2 and the alert substitution service can be avoided. However, if the dialed digits are analyzed and they do not match an emergency calling number 3-3 or a specified call type 3-4 for the associated communications account, the logic will then determine if an urgent message is waiting 3-5. If there is an urgent message waiting 3-5 the logic will delay the call setup 3-9 and then play the urgent message 3-8. The logic will then determine if input is requested for the urgent message 3-7 and if input is requested the logic will get the input 3-6 and send the input to the requesting party 3-10 via the appropriate communications path; e.g., short message service, e-mail, or other similar messaging protocol and network. If input is not requested 3-7 leg b the logic skips to determining if any other urgent messages are waiting 3-11 leg b. The logic will then determine if there are any other urgent messages waiting 3-11. If there are the logic goes though the loop starting at the delay call setup 3-9 and going through the logic of determining if any additional urgent messages are waiting 3-11 until there are no urgent messages waiting. Of course the calling party could be given an input sequence that would skip ahead to the call routing without playing an alert substitution or any urgent messages. This would allow the user to press a key or speak a phrase that would abort the process of providing the IS.

Once the logic determined there were no more urgent messages waiting 3-11 or the max number of urgent messages had been played (not shown), the logic would then route the communications to the intended recipient 3-12, determine if release link trunks were in use 3-13 and if they were being used release the trunks accordingly 3-14 while instructing the serving MSC (1-7 or 2-5) to connect the separate channels. Referring to FIG. 5, if release link trunks were not being used, the logic would monitor the trunks 5-19 to determine if they were still engaged in a conversation 5-20. If they were busy the logic would continue to monitor the trunks 5-19; however, if they were not busy the logic would release the trunks.

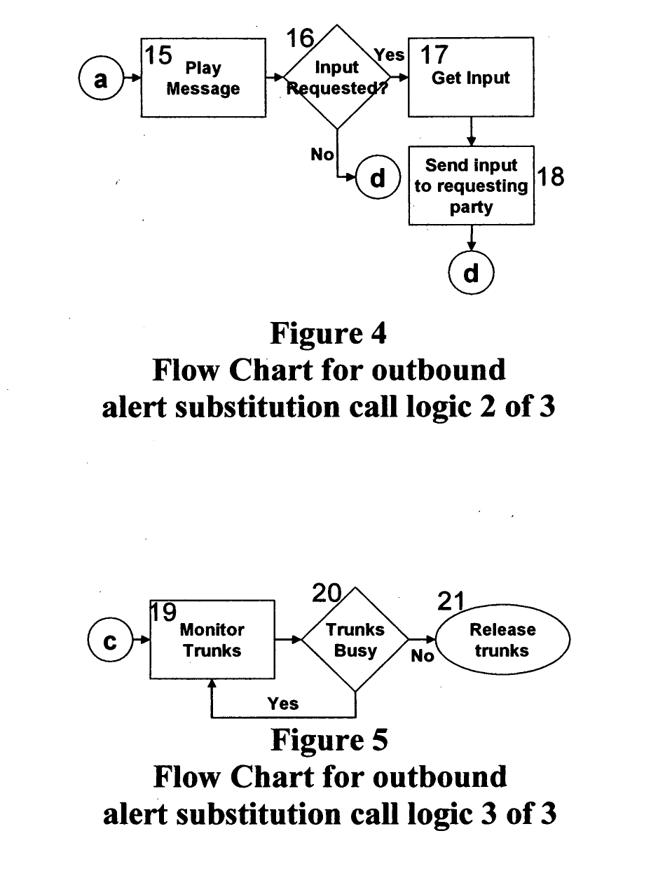

Referring now to FIG. 4, this pick up at the logic flow from FIG. 3-5 leg a. If the logic determined there were no urgent messages waiting, the logic would play any other messages 4-15 it had for the user. The logic would then determine if any input was needed 4-16. If input was needed 4-16 the logic would gather input 4-17 and send the input via the appropriate means to the requesting party 4-18 and then proceed with the logic sequence shown beginning at 3-12 leg d. If input was not required 4-16 the logic would default to the sequence shown beginning at 3-12 leg d.

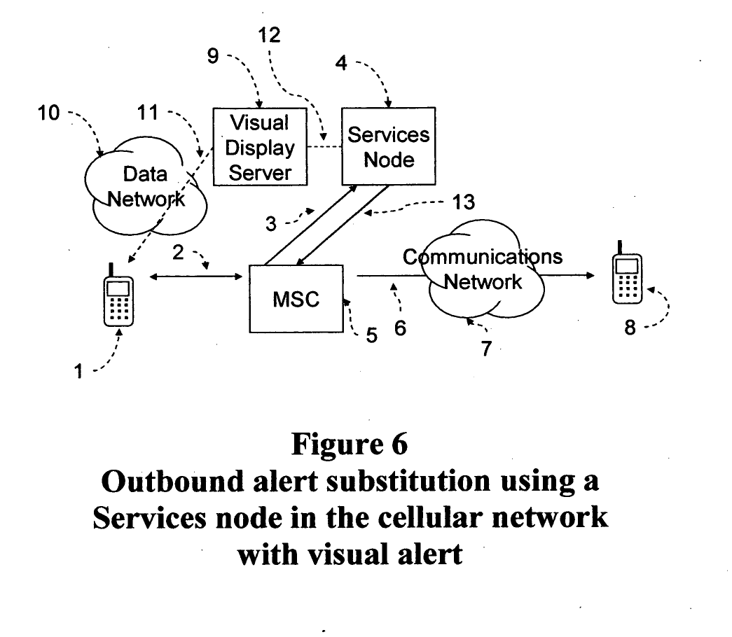

Referring to FIG. 6, the architecture is similar to FIG. 2 with the exception of a visual display server 6-13, a data network 6-10 back to the calling party's communications device 6-1, and the associated connections 6-11 and 6-12. In this case the MSC 6-5 would first determine if the call was destine for an emergency call center or another similar address. If the call was so destined the services node 6-4 would not be involved in the call routing.

In the services node 6-4 architecture the incoming communications request 6-2 from the communications device 6-1 would arrive at the MSC 6-5 and be routed to the services node 6-4. The services node 6-4 would then apply the logic to determine if the call setup should be delayed, an urgent or other similarly marked message should be played, and input collected before call setup progressed.

If the call was destined to be routed while the message was being played to the user of communications device 6-1, the services node 6-4 would route the communications request over the communications path 6-9 to the MSC 6-5 using the identity of the communications device 6-1 and normal call setup would proceed. The call routed back over the communications path 6-9 would be marked to indicate that the services node 6-4 had already processed the call, thus eliminating the potential for the MSC 6-5 to attempt to reroute the call back to the services node 6-4. Concurrently with handling the audio alert on channel 6-3 the service node 6-4 determines a visual display is needed. The service node 6-4 would then query the visual display server 6-13 over the communications path 6-12 to indicate the need for a visual display to communications device 6-1. The visual display server 6-13 would then send the appropriate visual IS to the communications device 6-1 for display on the associated screen 6-13. If desirable. It can be appreciated that the services node 6-4 and the visual display server 6-13 can be combined into a single entity and that data network 6-10 can be incorporated into MSC 6-5 or they may share various components. When the communications path 6-9 indicates that the alerting interval is complete and the communications path to 6-8 has been established, the services node 6-4 would release the call and instruct MSC 6-5 to bridge the conversations on channels 6-3 and 6-9 together. The services node 6-4 would also inform the visual display server 6-13 that the communications session had commenced and the visual display server 6-13 would determine if the visual content should be continued or terminated. One skilled in the art, utilizing this disclosure, can determine how the services node architecture can easily be adapted to be controlled by an SCP, CAMEL, IP Multimedia Subsystem, or other similar means.

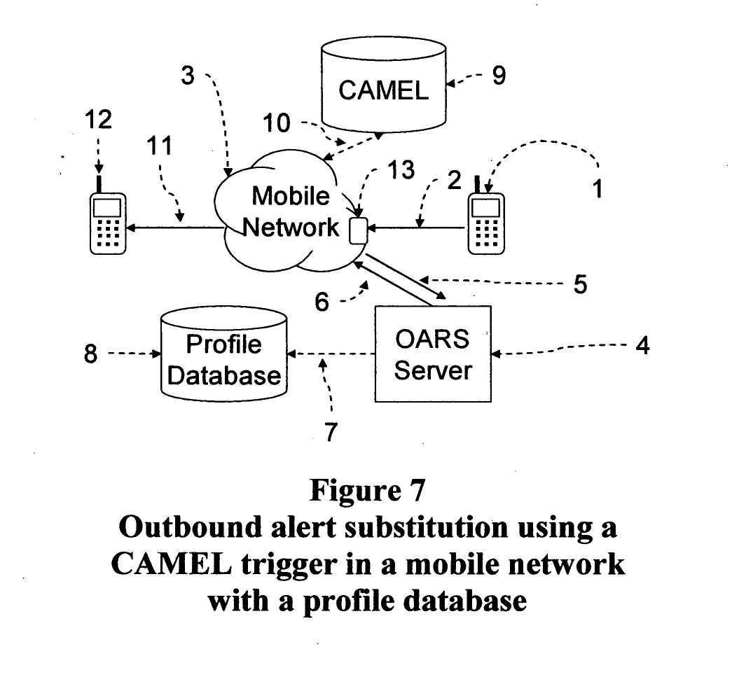

Referring to FIG. 7, this shows a platform providing OARS 7-4 using a CAMEL trigger 7-13 in a mobile network 7-3 that first queries 7-7 a profile database 7-8 to assist in determining which IS to provide to the CP 7-1. The sequence begins when the CP 7-1 places an outbound communications attempt 7-2 to the mobile network 7-3. This communications attempt 7-2 encounters a CAMEL trigger 7-13 that cause the CAMEL server 7-9 to be queried 7-10 to determine how the communications attempt 7-2 should be handled. In the sequenced disclosed in FIG. 7 the CAMEL server 7-9 would instruct the mobile network 7-3 to route the communications attempt to the OARS server 7-4. The OARS server would then query 7-7 a profile database 7-8, which can optionally be internal to the OARS server 7-4, to assist, at least in part, to determine which IS should be presented to the CP 7-1. The profile database can optionally be connected 7-14 to a location server 7-15 that is capable of locating the CP 7-1 to assist in determining, at least in part, the content of IS to provide to the CP 7-1. The location server 7-15 could also optionally be capable of determining the location of the CdP 7-12 to assist in determining the content of IS to provide to the CP 7-1. The OARS server 7-4 would then present the IS on the audio channel of the communications path 7-2 to the CP 7-1. Optionally the OARS server 7-4 may provide a visual information service as well through a visual information server (not shown). The OARS server 7-4 would then route the communications path 7-6/7-11 to the CdP 7-12. The OARS server 7-4 would optionally reduce level or eliminate the audio path on the outbound portion communications path 7-6 to the CdP 7-12. The OARS server 7-4 would then monitor the communications path 7-6 to the CdP 7-12 to determine when the alerting phase of the communications session was complete. During this time the OARS server 7-4 would provide the selected IS to the CP 7-1. The audio IS could optionally be accompanied or replaced by a visual IS provided to the CP 7-1.

It will be understood that the invention is not restricted to the illustrated embodiments and that various modifications can be made within the scope of the following claims.

For one aspect, the present invention provides a system that is capable of detecting an outgoing communications attempt and replacing an alert signal with an information service to the party originally placing the outbound communications attempt. This information service can be presented via an audio message, a visual message, a video, or some combination of these methods.

An alternative aspect of the invention allows for the detection of a specific address as the target of the communications session and alerting or eliminating the information service accordingly.

A further alternative aspect of the invention allows a message to be left by third party to be presented to the calling party during the alerting interval of an outbound communications session. This aspect can optionally allow the calling party to record their input to be used to further structure the service or to be delivered back to the third party leaving the message.

A further alternative aspect of the invention allows the detection and utilization of the called party address to determine the content of the information service. This would trigger the platform providing the information service to alter the information service accordingly. It is also possible that the called party address would trigger the platform providing the information service to not present an information service. This would be particularly helpful in instances such as when dialing an emergency services number.

A further alternative aspect of the invention allows the normal alert tone from the called party to be played simultaneously with the information service. The normal alert tone could be reduced in volume in order for the information service to be better heard and understood. The playing of the normal alert tone from the network would allow the calling party to hear any network based messages or other tones while still receiving the information service.

A still further alternative aspect of the invention allows is to utilize the intelligent network functionality of the mobile network such as CAMEL or IMS to identify the outbound call attempt as eligible for an information service. It is also an alternative aspect of the current invention to utilize intelligent network or Next Generation Network Architecture (NGNA) such as IMS to provide the content, audio, or display of information service to the calling party.

A further alternative aspect of the invention allows the detection and utilization of the calling party location to determine the content of the information service. This would trigger the platform providing the information service to alter the information service accordingly and would be particularly helpful in alerting the calling party to alternative providers of services, emergency situations, or other events in proximity to their current location.

A further alternative aspect of the invention allows the detection and utilization of the called party location to determine the content of the information service. This would trigger the platform providing the information service to alter the information service accordingly and would be particularly helpful in mapping applications or steering services utilizing OARS.

Other modifications, features, and embodiments of the present invention will become evident to those of skill in the art. It should be appreciated, therefore, that many aspects of the present invention were described above by way of example only and are not intended as required or essential elements of the invention unless explicitly stated otherwise. Accordingly, it should be understood that the foregoing relates only to certain embodiments of the invention and that numerous changes may be made therein without departing from the spirit and scope of the invention as defined by the following claims. It should also be understood that the invention is not restricted to the illustrated embodiments and that various modifications can be made within the scope of the following claims.

What is claimed is:

1. The method of:
detecting an outgoing communications session
detecting the alert associated with the communications session
playing a substitute message in place of the alert provided by the network
detecting when the alert sequence is completed
terminating the playing the substitute message in response to the completed alert sequence

2. The method of claim 1 where the communications session is a telephone call.

3. The method of claim 1 where if the outgoing communications session is an emergency call and the call is routed without playing a message.

4. The method of claim 2 where if the message to be played is marked accordingly the call setup is delayed and a message is played.

5. The method of claim 4 where input can be given by the calling party in response to the message played.

6. The method of claim 2 where the message is played simultaneously with the alert tone from the network.

7. The method of claim 1 where the method of detecting an outgoing communications session is CAMEL.

8. The method of claim 1 where the selection of the substitute message is based at least partly on the location of the calling party

9. The method of claim 1 where the method is primarily performed by the calling party's communications device.

10. The method of claim 1 where the substitute message provides, at least in part, a visual component.

11. An apparatus consisting of at least
a telecommunications network
a system for detecting an outgoing call attempt
a system for detecting the alerting condition on the outgoing call
a system for replacing the outgoing call alert with a specified message.

12. The apparatus of claim 11 where the telecommunications network serves wireless terminals.

13. The apparatus of claim 11 where the user specified message requires the input of the calling party.

14. The apparatus of claim 13 where the calling party input is provided utilizing the keypad of the communications device.

15. The apparatus of claim 13 where the calling party input is provided utilizing speech detection.

16. The apparatus of claim 13 where the calling party input instructs the apparatus to alter its logic flow.

17. The apparatus of claim 13 where the calling party provided input is muted on the path to the called party.

18. The apparatus of claim 11 where the user specified message is altered if the outgoing communications is directed to an address that is in a list of prespecified addresses.

19. The apparatus of claim 11 where the user specified message is triggered at least partially by the location of the calling communications device.

20. The apparatus of claim 11 where the user specified message is presented, at least in part, as a visual image associated with the calling party's communications device.

21. A system capable of replacing the audible alert of an outgoing call attempt with a second audible message directed to the user of the communications device originating the call attempt.
